(19) United States
(12) Patent Application Publication
(10) Pub. No.: US 2016/0031294 A1
(43) Pub. Date: Feb. 4, 2016

(54) SHADING DEVICE FOR A TRANSPARENT SURFACE PART OF A MOTOR VEHICLE

(71) Applicants: MATTHIAS MAIER, Esslingen (DE); HERBERT WALTER, Ebersbach (DE); RONALD MEYER, Ostfildern (DE)

(72) Inventors: MATTHIAS MAIER, Esslingen (DE); HERBERT WALTER, Ebersbach (DE); RONALD MEYER, Ostfildern (DE)

(21) Appl. No.: 14/812,569

(22) Filed: Jul. 29, 2015

(30) Foreign Application Priority Data
Aug. 1, 2014 (DE) 10 2014 215 151.1
Sep. 16, 2014 (DE) 10 2014 218 566.1

(51) Int. Cl. B60J 1/20

(52) U.S. Cl. CPC B60J 1/2011; B60J 1/2066

(57) ABSTRACT

Shading device for a transparent surface part of a motor vehicle having a shading structure, two lateral guide arrangements fixed with respect to the vehicle and flanking a displacement travel of the shading structure on opposite sides, and a pull-out profile arranged on a front end region of the shading structure. A drive device for displacement of the pull-out profile is provided, and has a guidance strand extending on the front end region of the shading structure and protruding into associated receiving spaces in the region of the lateral guide arrangements. The pull-out profile includes a middle part and two telescopic sections guided in the middle part and provided with guide tracks extending along the pull-out profile for the guidance strand sections of the guidance strand to ensure a relative displaceability between the telescopic and guidance strand sections and to prevent spreading of the guidance strand sections.

### CROSS-REFERENCE TO RELATED APPLICATIONS

This application claims priority from German Patent Application No. 10 2014 218 566.1 and German Patent Application No. 10 2014 215 151.1, the disclosures of which are hereby incorporated by reference in their entireties into this application.

### FIELD OF THE INVENTION

The invention relates to a shading device for a transparent surface part of a motor vehicle, having a flexible shading structure which can be displaced between a rest position, in which it is stowed in a compact manner, and a shading position, in which it covers the transparent surface part, in a vehicle interior, having two non-parallel lateral guide arrangements which are fixed with respect to the vehicle and which flank a displacement travel of the shading structure on opposite sides, and having a dimensionally stable pull-out profile which is arranged on a front face end region of the shading structure as viewed in the pulling-out direction, the pull-out profile having assigned thereto drive means for parallel displacement of the pull-out profile between the rest position and the shading position of the shading structure, and having a flexible transverse guidance strand which extends on the front face end region of the shading structure transverse to the pull-out direction of the shading structure over the width thereof and with a respective lateral guidance strand section in the region of opposite lateral guide arrangements protrudes into associated receiving spaces, in a manner dependent on the displacement travel of the shading structure.

### BACKGROUND OF THE INVENTION

A shading device of said type is known from EP 1 800 922 B1. The known shading device is provided for a rear window of a passenger motor vehicle and has a flexible shading structure which is held, such that it can be wound up and unwound, on a winding shaft. In the pulled-out condition, the shading structure has a rectangular shape. On a front face end region of the shading structure, as viewed in the pulling-out direction, is arranged a pull-out profile which is held by means of lateral guide carriages in lateral guide arrangements, which are fixed with respect to the vehicle. The lateral guide arrangements are assigned flexible shafts serving as drive means which displace the guide carriages in synchronism in such a manner that the pull-out profile is displaced in parallel fashion between a rest position of the shading structure and a shading position of the shading structure on the lateral guide arrangements. The guide arrangements, which are fixed with respect to the vehicle, are not extending in parallel to each other, but are oriented to be obliquely converging in the type of trapezoidal legs. Therein, the distance of the guide arrangements in the region of the shading position of the pull-out profile is less than the width of the shading structure, so that lateral shading structure sections protrude into receiving pockets in the region of the lateral guide arrangements during displacement of the shading structure from the rest position to the shading position. On a front face end region, as viewed in the pulling-out direction, the shading structure is provided with a transverse guidance strip which stiffens the front face end region of the shading structure in order to facilitate introduction of the lateral shading structure sections into the receiving spaces in the region of the guide arrangements which are fixed with respect to the vehicle.

### SUMMARY OF THE INVENTION

It is an object of the invention to provide a shading device of the type mentioned in the introduction which ensures secure and reliable introduction of lateral shading structure sections into receiving spaces which are fixed with respect to the vehicle.

Said object is achieved in that the pull-out profile comprises a middle part and two lateral telescopic sections guided in said middle part, which are provided with sliding guide tracks extending along the pull-out profile for the lateral guidance strand sections of the transverse guidance strand, which ensure a relative linear displaceability between the telescopic sections and the guidance strand sections and equally give support to prevent spreading of the guidance strand sections. The sliding guide tracks extending along the pull-out profile form a longitudinally extended cavity which is matched to the dimensions of the lateral guidance strand sections, in order to achieve the desired linear guidance of said guidance strand sections. Corresponding sliding guide tracks are provided on both lateral telescopic sections in identical manner so that identical supports and linear guidances are achieved on both sides of the middle part of the pull-out profile. The solution according to the invention is in particular advantageous for use in the region of a rear window arrangement of a passenger motor vehicle which is a transparent surface part in the context of the invention. As an alternative, the shading device can also be assigned to another side window or front window region of a motor vehicle or even to a transparent roof part. Using the solution according to the invention allows complete shading of the respective transparent surface part, although the guide arrangements, which are fixed with respect to the vehicle, extend in a non-parallel fashion. Advantageously, said non-parallel and fixed to the vehicle guide arrangements are installed with respect to the vehicle interior in the region of the respective transparent surface part in such a manner that by the extension of the shading structure between said guide arrangements a complete shading and obscuring of the transparent surface part—as viewed from the vehicle interior—is obtained. A particularly favorable sunscreen and camouflage effect is ensured thereby.

In a refinement of the invention, the sliding guide track in each telescopic section is constituted by a sliding guide channel which aligns with a receiving slot in the middle part for retaining the transverse guidance strand. Thereby the transverse guidance strand is guided and supported over the entire length of the telescoping pull-out profile in a plane and rectilinearly, thus, bending out or spreading of the transverse guidance strand during corresponding displacement moves of the pull-out profile can be prevented reliably.

In a further refinement of the invention, the transverse guidance strand has a stiffness which is greater than a stiffness of the shading structure. Thus, support of the face end region of the shading structure is obtained even in the lateral shading structure sections where no linear guidance and support by the telescoping pull-out profile is provided.

In a further refinement of the invention, the transverse guidance strand is formed by stiffening of the front face end region of the shading structure as such, in particular by folding over and soaking with a curable fluid. Such a fluid may be an adequate resin. What is relevant is that the above mentioned flexibility of the lateral guidance strand sections remains ensured.

In a further refinement of the invention, the transverse guidance strand includes, between the lateral guidance strand sections, a middle strand section which has a design differing from that of the lateral guidance strand sections. The middle strand section can have the configuration of a synthetic material strip which is connected to the face end region of the shading structure by sewing, welding or adhesive bonding. The lateral guidance strand sections can be formed by stiffening or by separate synthetic material strip sections.

In a further refinement of the invention, the lateral guidance strand sections are formed by folding over and fixing of shading structure sections of the front face end region. Said guidance strand sections are preferably produced such that the shading structure is cut out in the region of the middle strand section during preparation of the cutting, so that longitudinal straps remain on both sides of the later middle strand section, which straps project in the longitudinal direction of the shading structure. Said straps are folded over by once or repeatedly creasing or by rolling in, and subsequently fixed in said folded-over position by sewing or welding or adhesive bonding or also by soaking with a curable fluid.

In a further refinement of the invention, the synthetic material strip is made of PTFE and has a width between 8 and 12 mm and a thickness between 0.3 and 0.5 mm. Advantageously, a synthetic material strip made of PTFE is used for the transverse guidance strand which has a width of 10 mm and a thickness of 0.4 mm. Production of the strip using PTFE allows high stiffness and all the same sufficient flexibility in order to allow bending of the transverse guidance strip in the region of the lateral guide arrangements into the respective receiving space. In addition, the corresponding elasticity of the PTFE strip remains constant over a wide range of temperatures. The PTFE strip is low-wear and light-weight. Preferably, the PTFE strip constituting the transverse guidance strand is adhesively bonded to the face end region of the shading structure or sewn into a respective face-side loop of the shading structure.

In a further refinement of the invention, the middle strand section is formed by folding over and fixing of a shading structure section of the front face end region. The middle strand section is preferably produced in that a cutting of the shading structure is made longer in the region of the middle strand section, as compared to the lateral guidance strand sections, so that in the region of the middle strand section an additional longitudinal strap remains which projects beyond the lateral guidance strand sections in the longitudinal direction of the shading structure. Said portion of the cutting is subsequently folded over by once or repeatedly creasing or by rolling in. For reinforcement, a reinforcement strip or a reinforcement band can be integrated in the folded-in region. As an alternative or in addition, after the creasing or rolling in, fixing of the longitudinal strap in the respectively folded-over position, is provided by sewing, welding, adhesive bonding, or also by soaking with a curable fluid. The folding over and fixing of the middle strand section can be performed in addition to accordingly folded-over and fixed lateral guidance strand sections. As an alternative, the lateral guidance strand sections can even be reinforced and/or stiffened in a manner differing from that of the middle strand section.

Further advantages and features of the invention will emerge from the claims and from the following description of a preferred exemplary embodiment of the invention, which is illustrated on the basis of the drawings.

### BRIEF DESCRIPTION OF THE DRAWINGS

FIG. 1 schematically shows a part of a passenger motor vehicle in the region of a rear window arrangement, which at the vehicle interior side is assigned an embodiment of a shading device according to the invention,

FIG. 2 is the illustration as per FIG. 1, in which the shading device has been transferred into its shading position,

FIG. 3 is an enlarged perspective illustration of a detail of the shading device as per FIGS. 1 and 2,

FIG. 4 is another perspective illustration of the shading device as per FIG. 3,

FIG. 5 shows a side view of the shading device as per FIGS. 1 to 4,

FIG. 6 is an enlarged schematic cross-sectional illustration of a subregion of the shading device as per FIGS. 1 to 5,

FIG. 7 is a further cross-sectional illustration of the shading device in a section plane parallel to the section plane as per FIG. 6,

FIG. 8 is a further cross-sectional illustration, in a further section plane which is parallel to that in the illustrations of FIGS. 6 and 7, of a subregion of the shading device as per FIGS. 1 to 7,

FIG. 9 schematically shows a shading structure of the shading device as per FIGS. 1 to 8,

FIG. 10 schematically shows a detail of a shading structure of a further embodiment of a shading device according to the invention,

FIG. 11 schematically shows a detail of a shading structure of a further embodiment of a shading device according to the invention, and

FIG. 12 schematically shows a further subregion of a shading structure similar to FIG. 11.

### DETAILED DESCRIPTION

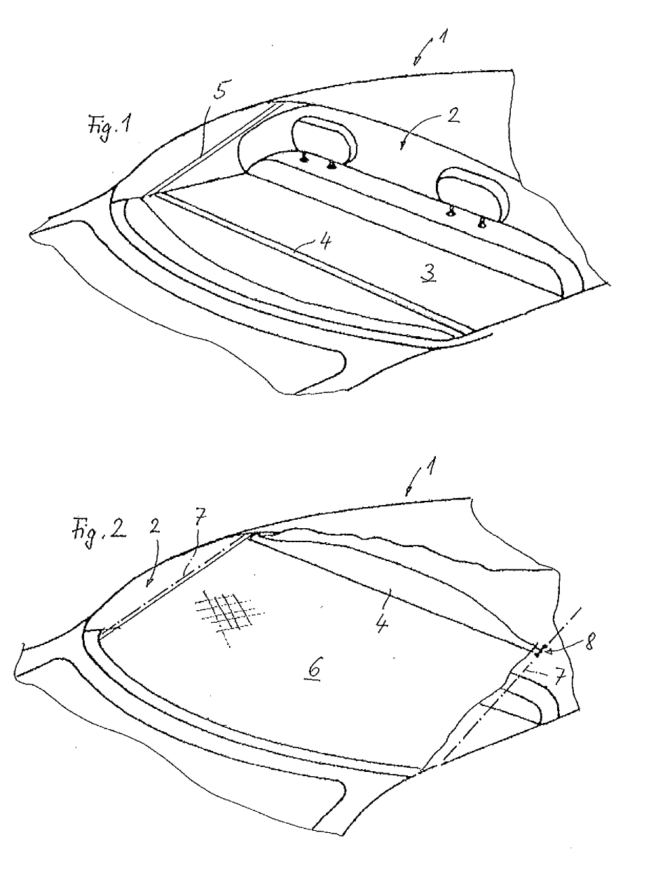

A passenger motor vehicle 1 has, as per FIGS. 1 and 2, a rear window arrangement 2 which delimits a vehicle interior compartment, above a vehicle sill, toward the rear. In the vehicle interior, there is provided below the rear window arrangement 2 a parcel shelf 3 which may be part of a load-bearing body structure of the passenger motor vehicle 1. The parcel shelf 3 is adjoined in the forward direction by a backrest arrangement of a rear seat bench.

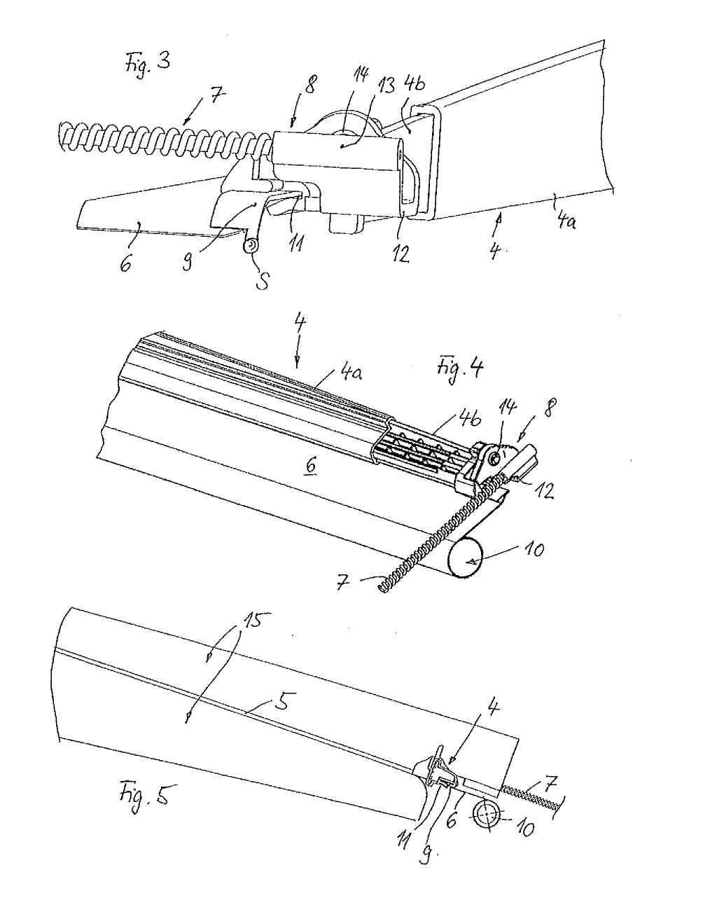

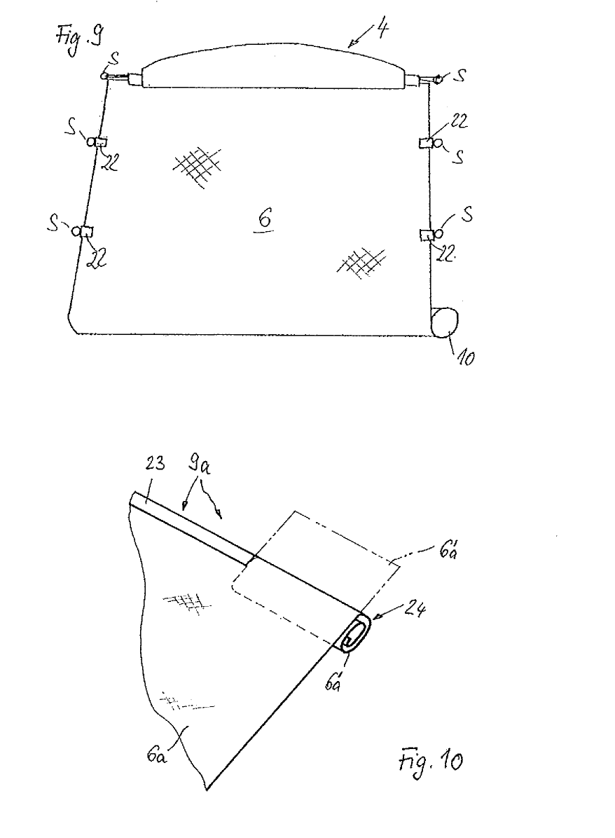

To reduce light radiation through the rear window arrangement 2 from the outside, the rear window arrangement 2 is assigned a shading device as per FIGS. 1 to 9, which will be described in more detail below. The shading device has a flexible shading structure 6 which, in the manner of a web, is held on a winding shaft 10 such that it can be wound up and unwound. The winding shaft 10 is mounted rotatably underneath the rear parcel shelf 3 with an axis of rotation extending in the vehicle transverse direction. In the region of the parcel shelf 3 there is provided a passage slot (not illustrated in any more detail) through which the shading structure 6 is passed during a movement from the rest position (FIG. 1) into the shading position (FIG. 2). The shading structure 6 has an at least substantially rectangular shape and is wound uniformly in multiple layers on the winding shaft 10. At a front face end region as viewed in the pulling-out direction, the shading structure 6 is fastened to a pull-out profile 4 which extends over the entire width of the shading structure 6. The pull-out profile 4 is, at its opposite face ends, held in longitudinally displaceable fashion by means of in each case one guide carriage 8 (FIGS. 3 and 4) in lateral guide arrangements which are fixed with respect to the vehicle. As can be seen from FIG. 1 and FIG. 2, the lateral guide arrangements which are fixed with respect to the vehicle are fastened in the region of C pillar sections of the body support structure. Each lateral guide arrangement has a guide slot 5 which is open toward the middle of the vehicle, the design and function of which guide slot will be described in more detail below. The guide slot 5 is preferably integrated in each case flushed into an interior lining part which is arranged in the region of the respective C-pillar section.

The pull-out profile 4 is made up of a middle part 4a, which is configured as a hollow profile, and two lateral telescopic sections 4b which are arranged on opposite sides of the middle part 4a and are guided in longitudinally displaceable fashion in the middle part 4a. The guide carriages 8 are connected to the face side of the respective telescopic section 4b. The two telescopic sections 4b are mounted in the middle part 4a so as to be displaceable in the longitudinal direction of the pull-out profile 4, in order that the overall length of the pull-out profile 4 can be varied. The variation of the overall length of the pull-out profile 4 is necessary as the lateral guide arrangements and also the guide slots 5 do not run parallel with respect to one another but are inclined toward the middle and accordingly taper toward one another proceeding from the parcel shelf 3 in the direction of the root lining of the vehicle interior. The pull-out profile 4 is, via its two telescopic sections 4b, mounted rotatably relative to the two guide carriages 8 by means of in each case one ball joint arrangement 14. The two ball joint arrangements 14 define, for the pull-out profile 4, an axis of rotation D relative to the opposite guide carriages 8, said axis of rotation being arranged eccentrically with respect to a central longitudinal axis of the pull-out profile 4. As can be seen from FIG. 6, the ball joint arrangement 14 comprises firstly a bearing journal 16 which projects laterally outward from the telescopic section 4b coaxially with respect to the axis of rotation D, and secondly a ball joint 17 which is mounted on the guide carriage 8 and into which the bearing journal 16 engages coaxially. An axial securing ring (not designated in any more detail) secures the bearing journal 16 axially on the ball joint 17.

The guide carriage 8 has a laterally outwardly projecting guide projection 12 which is angled upward and transitions into a cylindrical guide body 13 to which a drive transmission strand, which is rigid under compression, in the form of a flexible shaft 7 is coaxially connected (FIGS. 3 and 4). In a manner which is not illustrated in any more detail, the flexible shaft 7 is driven in longitudinally displaceable fashion synchronously with the opposite flexible shaft 7 by way of a gearwheel mechanism which is acted on by an electric drive motor.

The two lateral guide arrangements and both sides of the pull-out profile 4 and both sides of the shading structure 6 are designed mirror-symmetrically but otherwise identically to one another, such that in order to avoid repetitions, only one side will be described in detail.

The guide body 13 of the guide carriage 8 is guided in linearly displaceable fashion in a guide channel 20 of the lateral guide arrangement which is fixed with respect to the vehicle and which, within the meaning of the invention, serves as receiving space. The guide channel 20 furthermore guides the respective flexible shaft 7. The laterally outwardly projecting guide projection 12 of the guide carriage 8 projects into the guide slot 5, which is open toward the upwardly leading guide channel 20. Furthermore, the guide slot 5 is adjoined laterally to the outside and in the downward direction by a narrow receiving space 18 which comprises a widened support channel section 19. Both the guide slot 5 and the guide channel 20, the receiving space 18 and the support channel section 19 extend, as viewed in the longitudinal direction of the shading structure 6, continuously at least over an entire movement travel of the pull-out profile 4 and thus of the displacement travel of the shading structure 6 between its rest position (FIG. 1) and its shading position (FIG. 2).

The guide slot 5, the guide channel 20, the receiving space 18 and the support channel section 19 are integrated in a housing structure 15 which is composed of multiple interconnected shell sections. The shell sections may be produced from plastic or from metal. It can be seen from FIGS. 6 to 8 that the housing structure 15 is composed of three interconnected shell sections which are mounted fixedly with respect to the vehicle by being fixedly connected in particular to adjoining vehicle interior lining parts and/or load-bearing body parts.

The shading structure 6 is connected to the pull-out profile 4 via a transverse guidance strip 9 which serves as transverse guidance strand within the meaning of the invention and extends continuously over an entire width of the shading structure 6 transversely with respect to the pulling-out direction of the shading structure 6. The transverse guidance strip 9 exhibits greater stiffness than the flexible shading structure 6 and is produced from a PTFE strip with a width of 10 mm and a thickness of 0.5 mm. The transverse guidance strip 9 is connected to the front face end region of the shading structure 6 in continuous fashion over the entire width of the shading structure 6 by adhesive bonding or being sewn into a face-side loop. The transverse guidance strip 9 is held on the pull-out profile 4 by being inserted with a form fit into a receiving slot of the middle part 4a of the pull-out profile 4. The transverse guidance strip 9 is furthermore also connected to the pull-out profile 4 by way of its lateral guidance strip sections which extend in the region of the telescopic sections 4b of the pull-out profile 4. For this purpose, each telescopic section 4b is equipped with a sliding guide channel 11 by virtue of the respective lateral guidance strip section of the transverse guidance strip 9 being supported in linearly movable fashion. The lateral guidance strip sections present guidance strand sections within the meaning of the invention. The transverse guide channel 11 extends over a maximum pull-out length of the telescopic section 4b relative to the middle part 4a, such that the transverse guidance strip 9 is supported in linearly movable fashion at least largely over an entire width of the pull-out profile 4.

The transverse guidance strip 9 has, at its opposite face ends laterally outside the respective longitudinal edge of the shading structure 6, a tab projection onto which a pearl-like support body S is molded or fastened in some other way. Said support body S is inserted into the support channel section 19 of the housing structure 15 in the longitudinal direction of the shading structure 6 and prevents the transverse guidance strip 9 from being able to be pulled out of the support channel section 19 by a transverse force directed toward the middle of the vehicle. This is because the tapering of the receiving space at the transition from the support channel section 19 to the narrow receiving space 18 causes the support body S to be supported with a form fit in the transverse direction. The transverse guidance strip 9 is, by way of its lateral guidance strip sections, curved downward in the guide slot 5 and in the receiving space 18 and hereby guides the adjoining lateral shading structure sections of the shading structure 6 into the receiving space 18 and into the support channel section 19 during a longitudinal displacement of the pull-out profile 4 along the guide slots 5.

Accordingly, during a displacement of the shading structure 6 from the rest position into the shading position, the receiving space 18 and the support channel section 19 store the shading structure sections of the rectangular shading structure which have been inserted laterally into the guide slot 5. The lateral shading structure sections enter and pass through the respective guide slot 5 in a manner analogous to that in the prior art (EP 1 800 922 B1), firstly owing to the lateral guide arrangements and guide slots 5 which are fixed with respect to the vehicle and which taper toward one another and secondly owing to the parallel extending of the lateral longitudinal edges of the rectangular shading structure, during the winding-up or unwinding of the shading structure 6 by way of a longitudinal displacement of the pull-out profile 4.

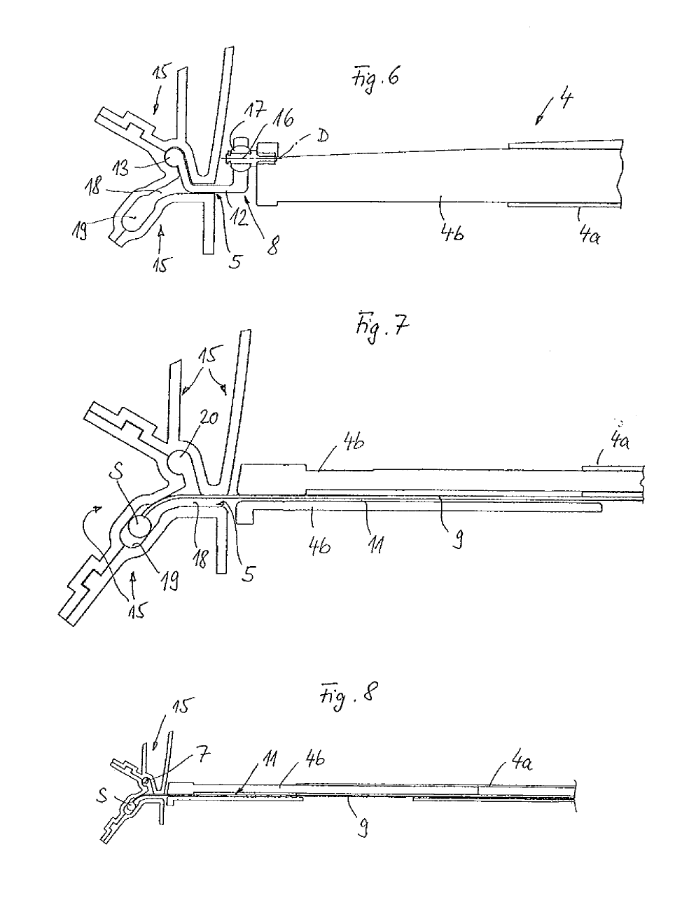

As is evident on the basis of FIG. 5, the transverse guidance strip 9 which is connected at the face side to the shading structure 6 forms a piping which is inserted with a form fit into the receiving slot, which is configured as a piping channel, of the middle part 4a. The sliding guide channels 11 of the telescopic sections 4b also form piping-like grooves, with the difference that, in the region of the sliding guide channels 11, the telescopic sections 4b are arranged so as to be longitudinally displaceable relative to the transverse guidance strip 9.

From FIG. 5 and from FIG. 1, it can be seen that the guide slots 5 in each housing structure 15 run firstly rectilinearly and secondly in the pulling-out plane of the shading structure 6. The receiving slot of the middle part 4a and the sliding guide channels 11 of the telescopic sections 4b are in alignment with one another in the longitudinal direction of the pull-out profile 4, resulting in rectilinear and planar support of the transverse guidance strip 9. This piping-like receptacle of the transverse guidance strip 9 in the pull-out profile 4 is provided at a distance from the axis of rotation D about which the pull-out profile 4 is mounted rotatably on the opposite guide carriages 8. The shading structure 6 is subjected to a permanent tensile force by virtue of a restoring spring arrangement being integrated in the winding shaft 10, which restoring spring arrangement exerts a torque on the winding shaft 10 in the winding-up direction. By means of this application of torque, the shading structure 6 exerts, by way of the transverse guidance strip 9 which is held in the pull-out profile 4, a torque on the pull-out profile 4 about the axis of rotation D, such that the pull-out profile 4 is oriented in the orientation as per FIGS. 4 and 5 while the pull-out profile 4 is moved from the rest position into the shading position or vice versa. The shading position or the end position may be assigned abutments which compensate the torque loading of the pull-out profile 4 and pivot the pull-out profile 4, in the corresponding end position, into a different orientation relative to the guide carriages 8.

In order that, over the further course of the length of the shading structure 6, the lateral shading structure sections are prevented from undesirably being pulled out of the corresponding receiving space 18, 19 with the respective housing structure 15, it is the case that, distributed over the length of the shading structure 6, on each side, the respective lateral longitudinal edge of the shading structure 6 is assigned two further support bodies S which are connected by way of fastening tabs 22 to the lateral shading structure sections. The support bodies S are also of pearl-like form and are coordinated in terms of their dimensions with the support channel section 19 so as to be longitudinally displaceable therein with play. During a displacement of the shading structure 6 by means of the pull-out profile 4 in the guide slots 5 of the housing structures 15, the further support bodies S also slide into the support channel sections 19 such that transverse support is realized substantially over the entire pulling-out length of the shading structure 6, which transverse support reliably prevents the shading structure from sliding out of the respective guide slot 5. As the shading structure 6 is wound up on the winding shaft 10, the support bodies S with the fastening tabs 22 are imperatively jointly wound up outside the respective face edge of the winding shaft 10, such that no change in the thickness of the winding layers occurs owing to said support bodies S.

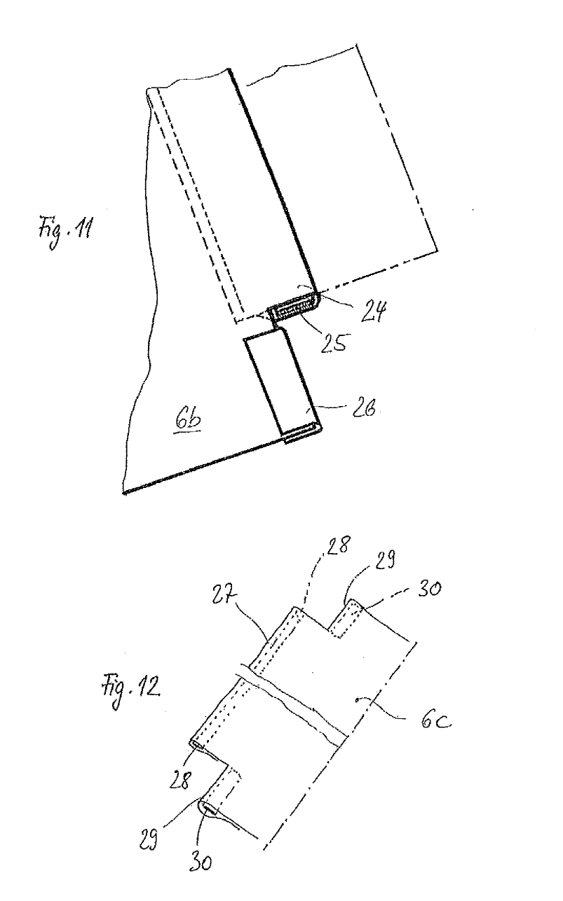

With reference to the illustration of FIG. 10, a flexible shading structure 6a including minor modifications as compared to the above described embodiments is provided for another embodiment of a shading device according to the invention. The shading structure 6a, described in more detail below, is employed in a shading device as described above with reference to the FIGS. 1 to 9. Essential difference with the shading structure 6a is that the front face end region, as viewed in the pulling-out direction, is provided with a transverse guidance strand 9a which has a differing design in the region of a middle guidance strand section 23 and in the region of two lateral guidance strand sections 24 adjoining on opposite sides to the middle guidance strand section 23. The middle guidance strand section 23 is a synthetic material strip which is adhesively bonded, welded or sewn to the face end region of the shading structure 6a analogous to the above described embodiments. The lateral guidance strand sections 24, however, are constituted by folded-over material sections 6′a of the shading structure 6a, wherein the folded-over shading structure sections 6′a, after the folding over, are additionally fixed by sewing, adhesive bonding, or welding, or by soaking using a curable fluid, preferably in the form of a resin. The folding over of the material sections 6′a can be performed by creasing or by rolling in according to FIG. 10. To obtain said material sections 6′a, the cutting of the shading structure 6a is cut out at the front face end region in the region of the middle guidance strand section 23 during its production, so that the lateral material sections 6′a project to the front beyond the middle guidance strand section like a flap or tab in the longitudinal direction of the shading structure 6a. Said protruding material sections 6′a can then be folded over and fixed in a manner as described. Owing to the folding over, there is a material thickening on the face end region of the shading structure 6a resulting in the needed transverse stiffness for the desired guidance and bending function of the lateral guidance strand sections 24.

With reference to the FIGS. 11 and 12, flexible shading structures 6b or 6c are provided, which include minor modifications as compared to the above described embodiments. Both the shading structure 6b and the shading structure 6c are employed with a shading device as described above with reference to FIGS. 1 to 9. Both with the shading structure 6b and with the shading structure 6c the front face end region, as viewed in the pulling-out direction, is provided with a middle strand section 24, 27 having a design differing from that of the lateral guidance strand sections 26, 29.

In the embodiment according to FIG. 11, the middle strand section 24 is constituted by a folded-over material section of the shading structure 6b, wherein the material section is placed around a stiffening band 25. The folded-over portion of the material section of the middle strand section 24 is fixed by sewing, adhesive bonding, welding or soaking using a curable fluid, preferably in the form of a resin. Prior to this, the reinforcement band 25 had been inserted in the folded-over material section. The lateral guidance strand sections 25 are composed of band strips which are crimped over on the outside in the face end region of the shading structure 6b and fixedly connected thereto by adhesive bonding, welding or sewing. The band strip 26 is designed as a separate band material and is connected to the face end region of the shading structure 6b by folding over around the face end region and corresponding fixing thereto.

In the embodiment according to FIG. 12, both the middle strand section 27 and the lateral guidance strand sections 29 are formed by folding-over of corresponding material sections of the shading structure 6c and by fixing the folded-over material sections to the two-dimensional fabric 6c. All the folded-over material sections are additionally stiffened by an inserted band 28, 30, wherein the inserted band 28 and the inserted bands 30 can each have differing designs. The inserted bands 28, 30 can be configured as stiffening strips or straps made of synthetic material or a textile material. The folding-over can be performed in the same manner, as described above, by creasing or rolling in. After the folding over, the folded-over portion of the material section is fixed both in the region of the middle strand section 27 and in the region of the lateral guidance strand sections 29, preferably by sewing, adhesive bonding, welding or by soaking using a curable fluid.

1. A shading device for a transparent surface part of a motor vehicle, having a flexible shading structure which can be displaced between a rest position, in which it is stowed in a compact manner, and a shading position, in which it covers the transparent surface part, in a vehicle interior, having two non-parallel lateral guide arrangements which are fixed with respect to the vehicle and which flank a displacement travel of the shading structure on opposite sides, and having a dimensionally stable pull-out profile which is arranged on a front face end region of the shading structure as viewed in the pulling-out direction, the pull-out profile having assigned thereto drive means for parallel displacement of the pull-out profile between the rest position and the shading position of the shading structure, and having a flexible transverse guidance strand which extends on the front end face region of the shading structure transverse to the pull-out direction of the shading structure over the width thereof and with a respective lateral guidance strand section in the region of the opposite lateral guide arrangements protrudes into associated receiving spaces, in a manner dependent on the displacement travel of the shading structure, wherein the pull-out profile comprises a middle part and two lateral telescopic sections guided in said middle part, which are provided with sliding guide tracks extending along the pull-out profile for the lateral guidance strand sections of the transverse guidance strand, which ensure a relative linear displaceability between the telescopic sections and the guidance strand sections and equally give support to prevent spreading of the guidance strand sections.

2. The shading device as claimed in claim 1,
wherein the sliding guide track in each telescopic section is constituted by a sliding guide channel which aligns with a receiving slot in the middle part for retaining the transverse guidance strand.

3. The shading device as claimed in claim 1, wherein the transverse guidance strand has a stiffness which is greater than a stiffness of the shading structure.

4. The shading device as claimed in claim 3, wherein the transverse guidance strand is configured as a synthetic material strip which is connected to the face end region of the shading structure by sewing, by welding or by adhesive bonding.

5. The shading device as claimed in claim 4, wherein the synthetic material strip is made of PTFE and has a width between 8 and 12 mm and a thickness between 0.3 and 0.5 mm.

6. The shading device as claimed in claim 5, wherein the transverse guidance strand is formed by stiffening of the front face end region of the shading structure as such, in particular by folding over and soaking with a curable fluid.

7. The shading device as claimed in claim 6, wherein the transverse guidance strand includes, between the lateral guidance strand sections, a middle strand section which has a design differing from that of the lateral guidance strand sections.

8. The shading device as claimed in claim 7, wherein the lateral guidance strand sections are formed by folding over and fixing of shading structure sections of the front face end region.

9. The shading device as claimed in claim 7, wherein the middle strand section is formed by folding over and fixing of a shading structure section of the front face end region.

10. The shading device as claimed in claim 8, wherein the shading structure sections are fixed by sewing, welding or adhesive bonding.
